(19) United States
(12) Patent Application Publication
(10) Pub. No.: US 2010/0102597 A1
(43) Pub. Date: Apr. 29, 2010

(54) Glass Run With Integrated Upper Reveal

(76) Inventor: Peter John Ellis, Rochester Hills, MI (US)

Correspondence Address: MAGNA INTERNATIONAL, INC., 337 MAGNA DRIVE, AURORA, ON, L4G-7K1, CA

(21) Appl. No.: 12/531,498

(22) PCT Filed: Mar. 11, 2008
(86) PCT No.: PCT/CA08/00454

§ 371 Date: Sep. 16, 2009

Related U.S. Application Data
(60) Provisional application No. 60/918,422, filed on Mar. 16, 2007.

(51) Int. Cl. B60J 1/08; B60J 10/04

(52) U.S. Cl. 296/201; 49/475.1

(57) ABSTRACT

An integrated glass run assembly is provided for a motor vehicle door frame having a header section defining a window opening. The integrated glass run assembly includes a retention portion adapted to be mounted to the header section. The retention portion includes a reveal surface disposed outboard of the header section. A decorative trim is secured along the reveal surface. The integrated glass run assembly also includes a window receiving portion co-extruded with the retention portion. The window receiving portion includes a channel for engagement with a window pane.

### BACKGROUND OF THE INVENTION

1. Field of the Invention

The invention relates to a glass run channel for a motor vehicle door. More particularly, the invention relates to a glass run channel with an integrated upper reveal.

2. Description of Related Art

Motor vehicle doors typically include a metal header with an outwardly extending flange. A reveal molding is commonly secured along the flange and includes a reveal surface that is visible along the exterior of the door. A separate glass run channel is then fixedly secured to the reveal molding for receiving a window pane in a closed position.

### SUMMARY OF THE INVENTION

According to one aspect of the invention, an integrated glass run assembly is provided for a motor vehicle door frame having a header section defining a window opening. The integrated glass run assembly includes a window receiving portion adapted for receiving a window pane. The window receiving portion includes a main body and spaced apart first and second legs extending out therefrom to define a window receiving channel. The integrated glass run assembly also includes a retention portion adapted to be mounted to the header section. The retention portion includes an outboard segment fixedly secured to the second leg of the window receiving portion to define a retention channel for receiving the header section therein. The outboard segment includes a reveal surface. A decorative reveal is secured to the outboard segment of the retention portion for providing an aesthetically pleasing appearance therealong.

### BRIEF DESCRIPTION OF THE DRAWINGS

The invention will be readily appreciated as the same becomes better understood by reference to the following detailed description when considered in connection with the accompanying drawings wherein:

FIG. 1 is a side view of a motor vehicle front door, partially cut away, including an integrated glass run assembly extending along a header section;

FIG. 2 is a cross-sectional view taken along Lines 2-2 in FIG. 1 of the integrated glass run assembly mounted to the header section; and

FIG. 3 is an exploded perspective view of the integrated glass run assembly for attachment to a header section of a motor vehicle rear door.

### DETAILED DESCRIPTION OF THE EMBODIMENT

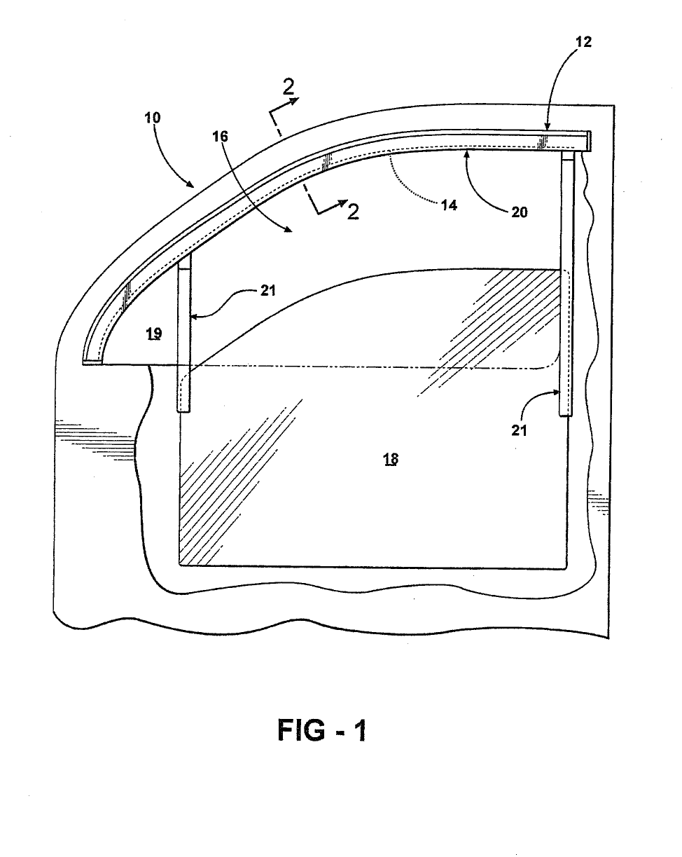

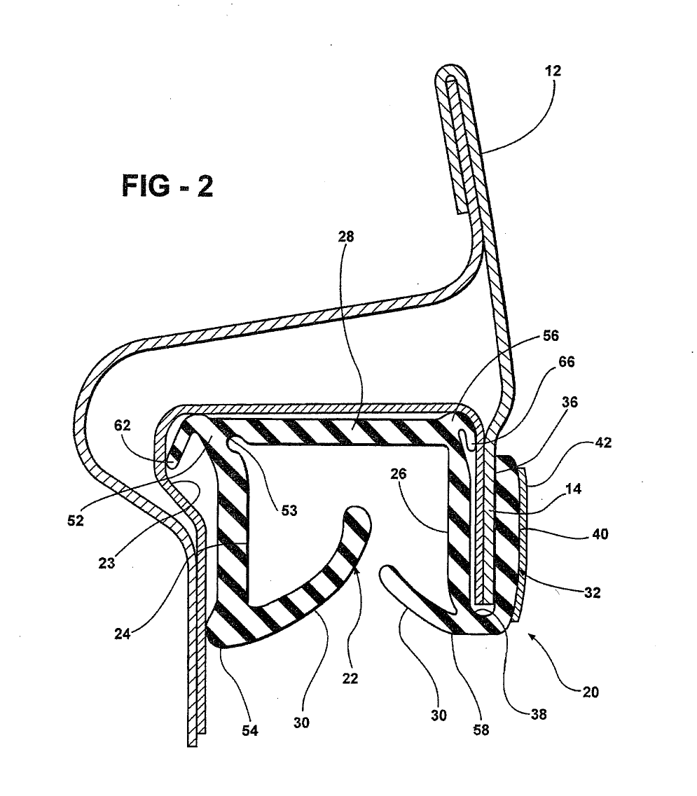

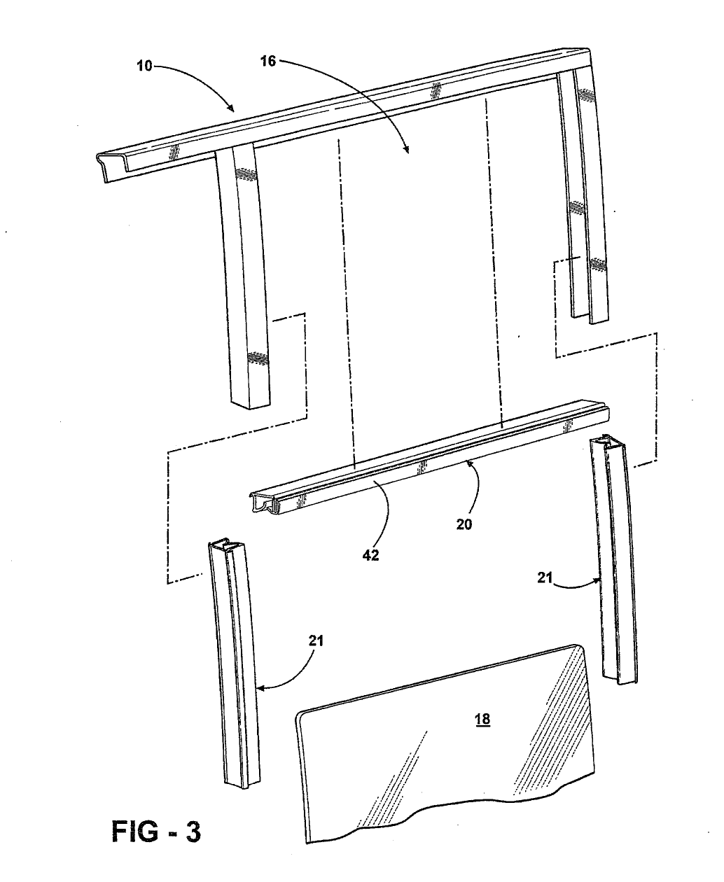

Referring to FIGS. 1 through 3, a motor vehicle door is generally shown at 10. In FIG. 1, the door 10 is a front door and in FIG. 3, the door 10 is a rear door. The following description addresses the front door with the understanding that the same applies equally to the rear door. The front door 10 includes a header section 12 of a door frame. The header section 12 includes a flange 14 extending out therefrom. The front door 10 also includes a window opening 16. A retractable window pane 18 selectively closes the window opening 16 and a fixed window pane 19 closes a remaining portion of the window opening 16. Glass run channels 21 are also positioned along a division post and a B-pillar for receiving the retractable 18 and fixed 19 window panes.

An integrated glass run assembly, generally shown at 20, is an elongated molding extending along the header section 12 of the door frame. As shown in FIG. 1, the integrated glass run assembly 20 may be curved to match the contour of the header section 12. The integrated glass run assembly 20 includes a window receiving portion, generally indicated at 22, for receiving the retractable 18 and fixed 19 window panes therein. The window receiving portion 22 is disposed within a channel 23 of the header section 12. The window receiving portion 22 includes spaced apart first 24 and second 26 legs extending out from a main body 28. The first leg 24 extends between a connecting end 52 and a free end 54, and the second leg 24 extends between a connecting end 56 and a free end 58. Each free end 54, 58 includes a flexible lip 30 secured thereto to contact the window panes 18, 19 and provide sealing engagement between the window panes 18, 19 and the integrated glass run assembly 20.

Each connecting end 52, 56 includes a respective projection 62, 66 disposed within the channel 23 of the header section 12. Each projection 62, 66 engages and abuts the door frame to provide locking engagement therewith. The first leg 24 and the main body 28 define a hinge 53 therebetween to provide flexible movement of the first leg 24 relative to the main body 28. It is contemplated that the second leg 26 and the main body 28 could also define a hinge therebetween without exceeding the scope of the invention.

The glass run channels 21 positioned along the division post and the B-pillar, as shown in FIGS. 1 and 3, have similar characteristics as the window receiving portion 22 of the integrated glass run assembly 20 described above. The glass run channels 21 are molded to the integrated glass run assembly 20 to further restrict the movement of the window panes 18, 19 received therein and guide the retractable window pane 18 in the proper orientation during vertical movement.

The integrated glass run assembly 20 also includes a retention portion, generally indicated at 32, adjacent the window receiving portion 22. The retention portion 32 includes an outboard segment 36 that is fixedly secured to the second leg 26 of the window receiving portion 22. The outboard segment 36 and the second leg 26 define a retention channel 38 therebetween. The retention portion 32 is attached to the flange 14 of the header section 12 by mounting the outboard segment 36 and second leg 26 around the flange 14 such that the flange 14 is fixedly secured within the retention channel 38. The retention portion 32 may be fixedly mounted along the flange 14 by any of numerous known materials and methods including, but not limited to, adhesive or tape.

The integrated glass run assembly 20 is formed as an extruded member from TPV (thermoplastic vulcanisate) of different durometer values to meet varying flexibility and durability requirements. More specifically, the retention portion 32 has a durometer of approximately 40 D. It is, however, appreciated that the durometer for the retention portion 32 may vary.

The integrated glass run assembly 20 includes a reveal or “A” surface 40 extending along the outboard segment 36 of the retention portion 32. A decorative trim or upper reveal 42 is coupled to the reveal surface 40 to provide the integrated glass run assembly 20 with an aesthetically pleasing, finished exterior. The upper reveal 42 may be formed from any of numerous materials including, but not limited to, chrome film. Because the retention portion 32 is formed from TPV with a durometer of 40 D, the retention portion 32 provides a hard surface that allows the upper reveal 42 to be applied without wrinkling or other similar irregularities.

Finally, it is appreciated that the integrated glass run assembly 20 may be heat-formed to adapt to corners on the door frame. The integrated glass run assembly 20 is a lightweight, cost-effective, UV stable molding that provides for the upper reveal or decorative trim 42 to be incorporated with the glass run channel. Further, the integrated glass run assembly 20 could be co-extruded with sealing lips 30.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. An integrated glass run assembly for a motor vehicle door frame having a header section defining a window opening, said integrated glass run assembly comprising:
a window receiving portion adapted for receiving a window pane, said window receiving portion including a main body and spaced apart first and second legs extending out therefrom to receive the window pane therebetween;
a retention portion adapted to be mounted to the header section, said retention portion including an outboard segment fixedly secured to said second leg of said window receiving portion to define a retention channel for receiving the header section therein, said outboard segment having a reveal surface; and
an upper reveal secured to said outboard segment of said retention portion for providing an aesthetically appealing appearance therealong.

2. An integrated glass run assembly as set forth in claim 1 wherein said upper reveal is chrome film.

3. An integrated glass run assembly as set forth in claim 1 wherein each of said first and second legs extends between opposing connecting and free ends and includes a projection at said connecting end for engaging and abutting the door frame to provide locking engagement therewith.

4. An integrated glass run assembly as set forth in claim 3 including a flexible lip secured to said free end of each of said first and second legs and projecting into said window receiving channel for sealing engagement with the window pane.

5. An integrated glass run assembly as set forth in claim 4 wherein said retention portion is formed from TPV.

6. An integrated glass run assembly as set forth in claim 5 wherein said TPV has a durometer of approximately 40 D.

7. An integrated glass run assembly for a motor vehicle door frame having a header section defining a window opening, said integrated glass run assembly comprising:
a window receiving portion adapted for receiving a window pane, said window receiving portion including a main body and spaced apart first and second legs extending out therefrom to receive the window pane therebetween, each of said first and second legs extending between opposing connecting and free ends and including a projection at said connecting end for engaging and abutting the door frame to provide locking engagement therewith;
a retention portion adapted to be mounted to the header section, said retention portion including an outboard segment fixedly secured to said second leg of said window receiving portion to define a retention channel for receiving the header section therein, said outboard segment having a reveal surface; and
an upper reveal secured to said outboard segment of said retention portion for providing an aesthetically pleasing appearance therealong.

8. An integrated glass run assembly as set forth in claim 7 wherein said upper reveal is chrome film.

9. An integrated glass run assembly as set forth in claim 7 including a flexible lip secured to said free end of each of said first and second legs and projecting into said window receiving channel for sealing engagement with the window pane.

10. An integrated glass run assembly as set forth in claim 9 wherein said main body and said first leg define a hinge for flexible movement of the first leg relative to the main body.

11. An integrated glass run assembly as set forth in claim 10 wherein said retention portion is formed from TPV.

12. An integrated glass run assembly as set forth in claim 11 wherein said TPV has a durometer of approximately 40 D.

13. An integrated glass run assembly for a motor vehicle door frame having a header section defining a window opening, said integrated glass run assembly comprising:
a window receiving portion adapted for receiving a window pane, said window receiving portion including a main body and spaced apart first and second legs extending out therefrom to receive the window pane therebetween;
a retention portion adapted to be mounted to the header section, said retention portion including an outboard segment fixedly secured to said second leg of said window receiving portion to define a retention channel for receiving the header section therein, said outboard segment having a reveal surface; and
an upper reveal secured to said outboard segment of said retention portion for providing an aesthetically pleasing appearance therealong;
wherein said integrated glass run assembly is formed as an extruded member from a moldable material such that said window receiving and retention portions are solely supported by said moldable material.

14. An integrated glass run assembly as set forth in claim 13 wherein said decorative reveal is chrome film.

15. An integrated glass run assembly as set forth in claim 13 wherein each of said first and second legs extends between opposing connecting and free ends and includes a projection at said connecting end for engaging and abutting the door frame to provide locking engagement therewith.

16. An integrated glass run assembly as set forth in claim 15 including a flexible lip secured to said free end of each of said first and second legs and projecting into said window receiving channel for sealing engagement with the window pane.

17. An integrated glass run assembly as set forth in claim 16 wherein said retention portion is formed from TPV.

18. An integrated glass run assembly as set forth in claim 17 wherein said TPV has a durometer of approximately 40 D.
